(19) United States
(12) Patent Application Publication
(10) Pub. No.: US 2018/0281784 A1
(43) Pub. Date: Oct. 4, 2018

(54) USING A DRIVER PROFILE TO ENHANCE VEHICLE-TO-EVERYTHING APPLICATIONS

(71) Applicant: GM Global Technology Operations LLC, Detroit, MI (US)

(72) Inventor: Ying Huang, Shanghai (CN)

(21) Appl. No.: 15/475,450

(22) Filed: Mar. 31, 2017

(51) Int. Cl. B60W 30/09; B60W 50/00; B60W 50/14; B60W 10/18; B60W 10/04; B60W 40/08

(52) U.S. Cl. CPC B60W 30/09; B60W 50/0097; B60W 50/14; B60W 10/18; B60W 10/04; B60W 2040/0809; B60W 2720/10; B60W 2710/18; B60W 2710/20; B60W 2540/28; B60W 2050/143; B60W 40/08

(57) ABSTRACT

Examples of techniques for enhancing vehicle-to-everything applications are disclosed. In one example implementation, a method includes calculating, by a processing device, a threat level for a driver of a vehicle based on a driver profile for the driver. The method further includes determining, by the processing device, whether the threat level is indicative of an unsafe condition. The method further includes initiating, by the processing device, an intervention activity based at least in part on determining that the threat level is indicative of an unsafe condition.

### INTRODUCTION

The present disclosure relates to enhancing vehicle-to-everything applications using a driver profile.

A vehicle, such a car, motorcycle, a boat, or any other type of automobile may be equipped with a vehicular communication system that facilitates different types of communication between the vehicle and other entities. For example, a vehicular communication system can provide for vehicle-to-infrastructure (V2I), vehicle-to-vehicle (V2V), vehicle-to-pedestrian (V2P), and/or vehicle-to-grid (V2G) communication. Collectively, these may be referred to as vehicle-to-everything (V2X) communication that enables communication of information from the vehicle to any other suitable entity. Various applications (e.g., V2X applications) can use V2X communications to send and/or receive safety messages, maintenance messages, vehicle status messages, and the like.

### SUMMARY

In one exemplary embodiment, a computer-implemented method for enhancing vehicle-to-everything applications includes calculating, by a processing device, a threat level for a driver of a vehicle based on a driver profile for the driver. The method further includes determining, by the processing device, whether the threat level is indicative of an unsafe condition. The method further includes initiating, by the processing device, an intervention activity based at least in part on determining that the threat level is indicative of an unsafe condition.

In some examples, determining whether the threat level is indicative of an unsafe condition includes comparing the threat level to a threat level threshold for the driver. An example method may additionally include updating the driver profile based at least in part on determining that the threat level is indicative of an unsafe condition. In some examples, wherein the intervention activity includes presenting a warning message to the driver of the vehicle. In some examples, the intervention activity includes transmitting a warning message to another vehicle. In some examples, the intervention activity includes controlling the vehicle, wherein controlling the vehicle includes applying brakes, applying throttle, or changing a direction of the vehicle. An example method may additionally include generating the driver profile for the driver by collecting information about the driver and behaviors of the driver. In some examples, the driver profile includes a static portion and a dynamic portion.

In another exemplary embodiment, a system enhancing vehicle-to-everything applications includes a memory including computer readable instructions and a processing device for executing the computer readable instructions for performing a method. In examples, the method includes calculating, by a processing device, a threat level for a driver of a vehicle based on a driver profile for the driver. The method further includes determining, by the processing device, whether the threat level is indicative of an unsafe condition. The method further includes initiating, by the processing device, an intervention activity based at least in part on determining that the threat level is indicative of an unsafe condition.

In some examples, determining whether the threat level is indicative of an unsafe condition includes comparing the threat level to a threat level threshold for the driver. An example method may additionally include updating the driver profile based at least in part on determining that the threat level is indicative of an unsafe condition. In some examples, wherein the intervention activity includes presenting a warning message to the driver of the vehicle. In some examples, the intervention activity includes transmitting a warning message to another vehicle. In some examples, the intervention activity includes controlling the vehicle, wherein controlling the vehicle includes applying brakes, applying throttle, or changing a direction of the vehicle. An example method may additionally include generating the driver profile for the driver by collecting information about the driver and behaviors of the driver. In some examples, the driver profile includes a static portion and a dynamic portion.

In yet another exemplary embodiment a computer program product for enhancing vehicle-to-everything applications includes a computer readable storage medium having program instructions embodied therewith, wherein the computer readable storage medium is not a transitory signal per se, the program instructions executable by a processing device to cause the processing device to perform a method. In examples, the method includes calculating, by a processing device, a threat level for a driver of a vehicle based on a driver profile for the driver. The method further includes determining, by the processing device, whether the threat level is indicative of an unsafe condition. The method further includes initiating, by the processing device, an intervention activity based at least in part on determining that the threat level is indicative of an unsafe condition.

In some examples, the intervention activity includes controlling the vehicle, wherein controlling the vehicle includes applying brakes, applying throttle, or changing a direction of the vehicle. An example method may additionally include generating the driver profile for the driver by collecting information about the driver and behaviors of the driver. An example may additionally include storing the driver profile in a cloud data repository.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a vehicle including a processing system for enhancing vehicle-to-everything applications using driver profiles, according to embodiments of the present disclosure;

FIG. 2 depicts the processing system for enhancing vehicle-to-everything applications using driver profiles of FIG. 1, according to embodiments of the present disclosure;

FIG. 3 depicts a flow diagram of a method for enhancing vehicle-to-everything applications using driver profiles, according to aspects of the present disclosure;

FIG. 4 depicts a flow diagram of a method for enhancing vehicle-to-everything applications using driver profiles, according to aspects of the present disclosure; and

FIG. 5 illustrates a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for enhancing vehicle-to-everything applications by generating a driver profile for a driver and using the driver profile to determine threat levels for potential threats. If a threat level rises to a certain level, an intervention activity, such as sending a warning message to another vehicle, person, etc., can be implemented.

The present techniques use the driver profile to learn about the specific driver that is driving the vehicle. Accordingly, V2X communications can include information specific to that driver (e.g., different levels of warning, control interfaces, etc.) based on the specific driver and not merely general human factors. Additionally, the present techniques can be used to compare the driver's behavior at a current time as compared to the historical behavior of the driver. For example, the present techniques can detect dynamic changes for the specific driver (e.g., whether the driver is dizzy (based on a camera in the vehicle), whether the driver is rushing (based on the driver's calendar), whether the driver is experiencing a health condition (based on a wearable device of the driver), and the like). The present techniques can also be used to glean knowledge about other drivers in the vicinity. This provides for the better assessment of threats (e.g., potential collision risk) by knowing the other vehicles' drivers' behavior.

In additional embodiments, the present techniques can apply to and be used with advanced driver assistance systems (ADAS), active safety applications (i.e., sensor based applications), and the like. For example, a driver profile for a specific driver can be incorporated into an ADAS system to an provide intervention activity, such as when a threat level is indicative of an unsafe condition.

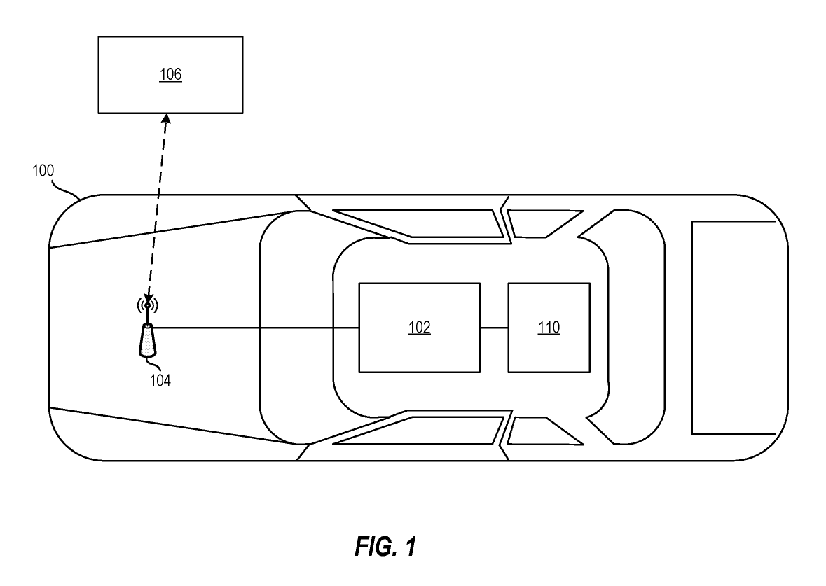

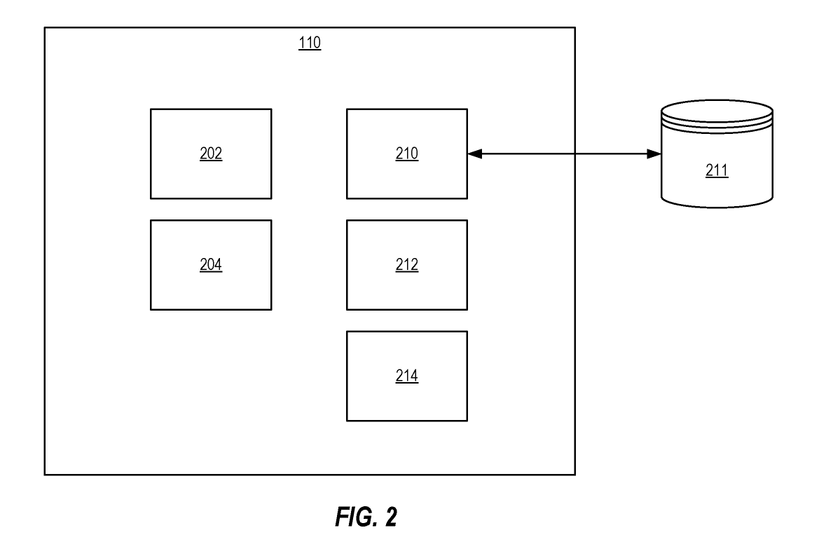

FIG. 1 depicts a vehicle 100 including a processing system 110 for enhancing vehicle-to-everything applications using driver profiles according to embodiments of the present disclosure. The vehicle 110 also includes a vehicular communication device and an antenna 104, which enable the processing system 110 to communicate to an external device 106. The processing system 110 is depicted in FIG. 2 and is described in more detail below.

The processing system 110 generates a user profile for the driver that defines characteristics of the driver and his driving behavior. The user profile can include static and dynamic portions that describe the behavior of the driver. For example, static portions can include the driver's average reaction time, average response (or action) time, driving history, average concentration level, and other aspects of the driver. Dynamic portions can include aspects of the driver's behavior that change based on circumstances, such as the driver's current health, whether the driver is inebriated, whether the driver is distracted, whether the driver is running late, whether the driver is operating on less sleep than normal, and the like. Each of these factors can be used to generate and update the driver profile over time.

The processing system 110 then calculates a threat level for the driver of the vehicle using the driver profile for the driver. The threat level is a value or parameter that indicates the probability or likelihood of a threat occurring. For example, if the processing system 100 determines that the driver is running late, the threat level increases. The processing system 110 continuously calculates the threat level based at least in part on the driver profile for the driver as it changes and based at least in part on other factors (e.g., weather, over vehicle's behavior, road conditions, and the like).

The processing system 110 determines whether the thread level is indicative of an unsafe condition (e.g., a threat) occurring. For example, the processing system 100 compares the calculated threat level to a threat level threshold for the driver. According to examples of the present disclosure, a particular threat level threshold is user defined, is determined based on the user's driving history, is based on average driver's behavior, is based on the user's current behavior, and the like. The threat level threshold can be dynamic in that it changes automatically over time based on changing circumstances, or the threat level threshold can be static (until changed by the driver manually, if at all).

If the processing system 100 determines that the threat level exceeds the threat level threshold value, the processing system 100 implements an intervention activity. In one example, the intervention activity includes warning an external device 106 that an unsafe condition is indicated. The external device 106 may be another vehicle, an individual, an authority (e.g., the police, etc.), and the like. To warn the external device 106 of the unsafe condition indication, the processing system 110 activates a vehicular communication device 102 associated with the vehicle 100 to send the indication to the external device 106, such as over a wireless antenna 104. The wireless antenna 104 can be a dedicated short range communication (DSRC) antenna, a cellular antenna, a wireless network (e.g., WiFi) antenna, and/or another suitable communication antenna. According to some aspects of the present disclosure, the vehicular communication device 102 utilizes vehicle-to-infrastructure (V2I), vehicle-to-vehicle (V2V), vehicle-to-pedestrian (V2P), and/or vehicle-to-grid (V2G) communication, and/or vehicle-to-everything (V2X) communication schemes/protocols.

In another example, the intervention activity is a warning message presented to the driver. For example, if the driver is distracted, the warning message can be presented to the driver in an effort to cause the drive to regain focus. In yet another example, the intervention activity controls the vehicle. For example, the processing system 110 may cause a vehicle control system (not shown) for controlling the vehicle to change an aspect of the vehicle, such as speed, direction, and the like.

FIG. 2 depicts the processing system 110 for enhancing vehicle-to-everything applications using driver profiles of FIG. 1 according to embodiments of the present disclosure. The processing system 110 includes a processing device 202, a memory 204, a driver profile engine 210, a threat level engine 212, and an intervention engine 214. The driver profile engine 210 is communicative with a driver profile repository 211.

The various components, modules, engines, etc. described regarding FIG. 2 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein may be a combination of hardware and programming. The programming may be processor executable instructions stored on a tangible memory, and the hardware may include the processing device 202 for executing those instructions. Thus a system memory (e.g., the memory 204) can store program instructions that when executed by the processing device 202 implement the engines described herein. Other engines may also be utilized to include other features and functionality described in other examples herein. Alternatively or additionally, the processing system 110 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that one or more of the driver profile engine 210, the threat level engine 212, and the intervention engine 214 can be implemented in a cloud computing environment, and the driver profile can be stored locally and/or remotely, such as in the cloud computing environment.

The driver profile engine 210 generates a driver profile for a driver of the vehicle 100. To generate the driver profile, the driver profile engine 210 collects information about the driver and the driver's behavior. Information about the driver and the driver's behavior can include how the driver is operating the vehicle (based on the driving data of vehicle speed, acceleration pedal, braking pedal, steering wheel, etc.), whether the driver is dizzy (based on a camera in the vehicle), whether the driver is rushing (based on the driver's calendar), whether the driver is experiencing a health condition (based on a wearable device of the driver), and the like.

The driver profile engine 210 can store the driver profile to the driver profile repository 211, which may be local to the processing system 211 or remote to the processing system 211 (e.g., a cloud data repository stored in a cloud computing environment). For example, the driver profile engine can store the driver profile to a cloud data repository so that it can be accessed in other vehicles for the same driver.

The threat level engine 212 calculates a threat level for the driver based on the driver profile of that driver. For example, the threat level engine 212 can calculate a likelihood of a front collision or a likelihood of a left or right turn (as described below).

The threat level engine 212 then uses the calculated threat level to determine whether the threat level is indicative of an unsafe condition (e.g., a front end collision, a left turn without a signal, etc.). In one example, the threat level engine compares the calculated threat level to a threat level threshold for the driver stored in the profile for the driver.

If the threat level engine 212 determines that the threat level is indicative of an unsafe condition, the intervention engine 214 initiates an intervention activity. The intervention activity can be one or more of including presenting (e.g., on a display of the vehicle 100) a warning to the driver, sending a warning to an external device 106 (e.g., another vehicle, another person, etc.), or controlling an aspect of the vehicle 100 (e.g., applying brakes, applying throttle, changing a direction of the vehicle 100, etc.), and the like. For example, the intervention engine 214 can send a warning to another vehicle (e.g., the external device 106) through the vehicular communication device 102 and antenna 104. The warning may enable a driver of the other vehicle to take a corrective action (e.g., slowing down to avoid the vehicle 100, moving out of the way of the vehicle 100, etc.).

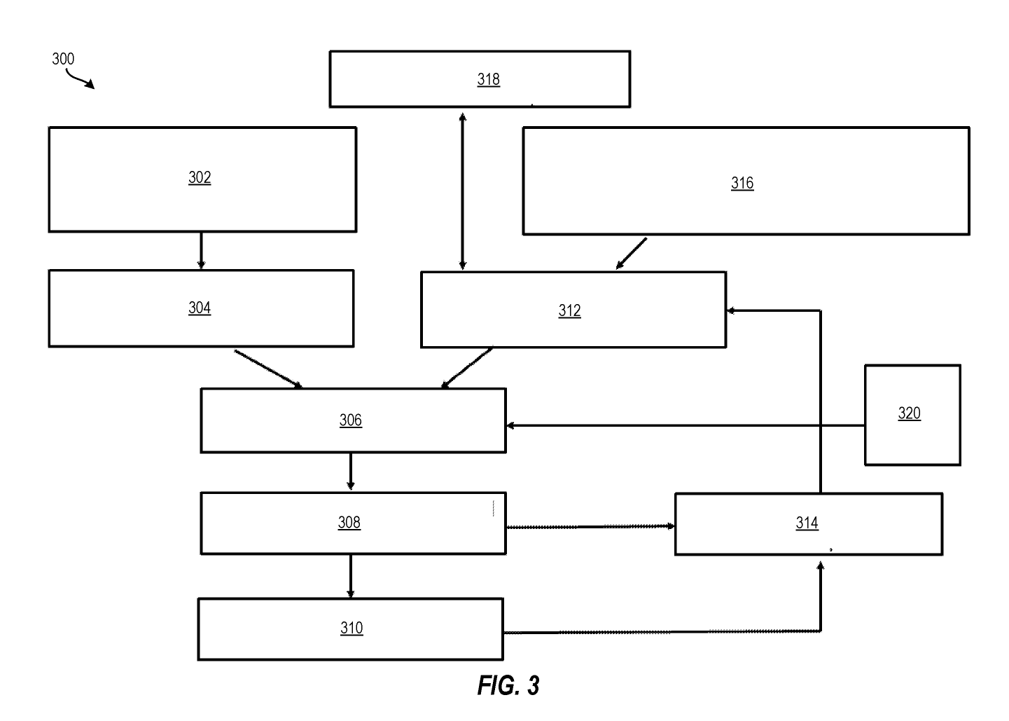

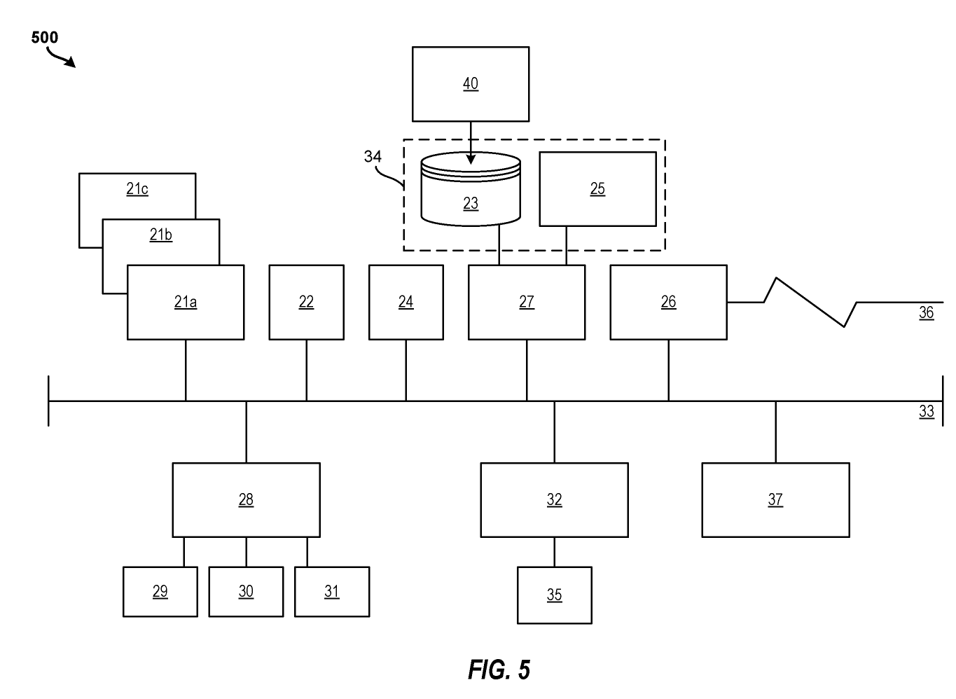

FIG. 3 depicts a flow diagram of a method 300 for enhancing vehicle-to-everything applications using driver profiles according to aspects of the present disclosure. The method 300 may be implemented, for example, by the processing system 110 of FIG. 1 and FIG. 2, by the processing system 500 of FIG. 5, or by another suitable processing system or device.

At block 302, the method 300 receives information to determine which remote vehicles are relevant. For example, remote vehicles can send location information to the vehicle 100 to indicate the location of the remote vehicles. The present vehicle 100 can determine which remote vehicles are relevant based on the location of the remote vehicles relative to the vehicle 100. At block 304, the method 300 determines which of the remote vehicles is a potential threat (e.g., a remote vehicle's trajectory may conflict with the host vehicle's trajectory at the same time). The threat level can then be calculated based on both a host vehicle and a remote vehicle's information such as speed, location, heading and the like (block 306) and the driver's profile of the vehicle 100 (block 312) and/or the profile for a driver of the remote vehicle (block 320).

Based on the calculated threat level, the method 300 decides whether to issue a warning to one of the drivers, to control the vehicle 100, or to do nothing (block 308). Based on this determination, the driver's action and the vehicle 100 (host vehicle) and remote vehicle behavior is observed (block 310) and used to compare and enhance the driver profile (block 314).

The driver's profile built at block 312 is based on collected driving information, including static and dynamic portions (block 316) and can be stored in a data store, such as a local or cloud data store (block 318).

Additional processes also may be included, and it should be understood that the processes depicted in FIG. 3 represent illustrations and that other processes may be added or existing processes may be removed, modified, or rearranged without departing from the scope and spirit of the present disclosure.

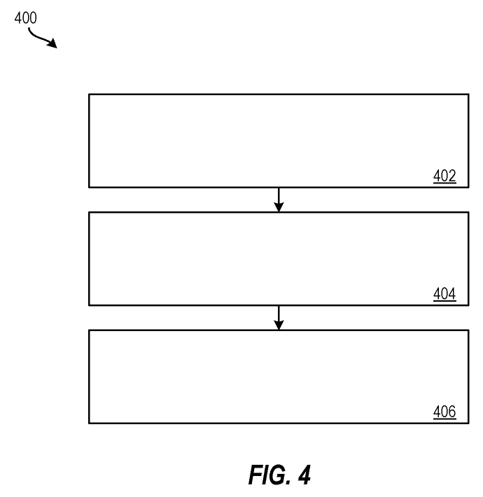

FIG. 4 depicts a flow diagram of a method 400 for enhancing vehicle-to-everything applications using driver profiles according to aspects of the present disclosure. The method 400 may be implemented, for example, by the processing system 110 of FIG. 1 and FIG. 2, by the processing system 500 of FIG. 5, or by another suitable processing system or device.

At block 402, the threat intervention engine 212 of the processing system 110 calculates a threat level for a driver of a vehicle based on a driver profile for the driver. At block 404, the threat level engine 212 of the processing system 110 determines whether the threat level is indicative of an unsafe condition. To do this, the threat level engine 212 can compare the threat level to a threat level threshold for the driver. At block 406, the intervention engine 214 of the processing system initiates an intervention activity based at least in part on determining that the threat level is indicative of an unsafe condition.

In additional examples, the method 400 may include generating the driver profile, by the drive profile engine 210 of the processing system 110, for the driver by collecting information about the driver and behaviors of the driver. The driver profile can include a static portion and a dynamic portion. The driver profile engine 210 can also update the driver profile based at least in part on determining that the threat level is indicative of an unsafe condition. For example, the user profile is updated so that future determinations of threat levels can be more accurate as a result of the previous determination.

Additional processes also may be included, and it should be understood that the processes depicted in FIG. 4 represent illustrations and that other processes may be added or existing processes may be removed, modified, or rearranged without departing from the scope and spirit of the present disclosure.

The present techniques are useful in a variety of scenarios. For example, driver profiles can be used to more accurately determining the likelihood of a front collision occurring so that a front collision warning can be issued, such as using V2X communication. Traditionally, time-to-collision is calculated as latency time+driver reaction time+action time+margin. Driver reaction time and action time represent factors of a typical human and do not account for a particular driver's behavior.

The present techniques account for the behavior of a specific driver by determining the driver's reaction time as a function of the driver's typical reaction time, the driver's current health condition, the driver's current concentration level, the driver's blood alcohol level, and/or any other relevant factors that can alter a driver's reaction time. The action time is also determined based on the specific driver as a function of the particular vehicle's deceleration capability, the driver's typical braking force, and the like. Accordingly, the specific driver's profile improves the accuracy of a time-to-collision calculation so that the driver and/or other vehicles (e.g., a target of the collision), emergency personnel, etc., can be warned of the potential collision.

In another example, driver profiles can be used to more accurately determine how likely a turn is to occur. The threat level calculation can be enhanced by the driver's profile by accounting for how likely the driver is to activate the turn signal during a turn. This may be used in a turn assist (e.g., left turn assist, right turn assist, u-turn assist) to alert other vehicles, etc., of the present vehicle's impending turn. In particular, a left turn assist is an application that alerts (e.g., using V2X communication) a driver and/or other vehicles of an unprotected left turn across traffic to aid in crash avoidance with opposite direction traffic. Left-turn assist, for example, is traditionally calculated as whether the left turn signal is blinking as {0, 1} (0 for off, 1 for on) multiplied by other factors. Again, this does not account for the behavior of a specific driver.

When utilizing left turn assist, the present techniques account for a specific driver's behavior by calculating a left turn likelihood as a left turn signal coefficient in the range from {[0 . . . 1]} multiplied by other factors. The left turn signal coefficient is equal to 1 when the left turn signal is on. When the left turn signal is off, the left turn signal coefficient is equal to the driver's turn signal coefficient, which is the number of times the driver uses the left turn signal divided by the overall number of left turns the driver makes. This provides the likelihood when a specific driver makes a turn without using the turn signal and can be used to implement left turn assist applications according to the techniques described herein.

It is understood that the present disclosure is capable of being implemented in conjunction with any other type of computing environment now known or later developed. For example, FIG. 5 illustrates a block diagram of a processing system 500 for implementing the techniques described herein. In examples, processing system 500 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 500.

Further illustrated are an input/output (I/O) adapter 27 and a network adapter 26 coupled to system bus 33. I/O adapter 27 may be a small computer system interface (SCSI) adapter that communicates with a hard disk 23 and/or other storage drive 25 or any other similar component. I/O adapter 27, hard disk 23, and storage device 25 are collectively referred to herein as mass storage 34. Operating system 40 for execution on processing system 500 may be stored in mass storage 34. A network adapter 26 interconnects system bus 33 with an outside network 36 enabling processing system 500 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 500 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system to coordinate the functions of the various components shown in processing system 500.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method for enhancing vehicle-to-everything applications, the method comprising:
calculating, by a processing device, a threat level for a driver of a vehicle based on a driver profile for the driver;
determining, by the processing device, whether the threat level is indicative of an unsafe condition; and
initiating, by the processing device, an intervention activity based at least in part on determining that the threat level is indicative of an unsafe condition.

2. The computer-implemented method of claim 1, wherein determining whether the threat level is indicative of an unsafe condition comprises comparing the threat level to a threat level threshold for the driver.

3. The computer-implemented method of claim 1, further comprising updating the driver profile based at least in part on determining that the threat level is indicative of an unsafe condition.

4. The computer-implemented method of claim 1, wherein the intervention activity comprises presenting a warning message to the driver of the vehicle.

5. The computer-implemented method of claim 1, wherein the driver profile is stored in a local data store or a remote data store.

6. The computer-implemented method of claim 1, wherein the intervention activity comprises controlling the vehicle, wherein controlling the vehicle comprises applying brakes, applying throttle, or changing a direction of the vehicle.

7. The computer-implemented method of claim 1, further comprising generating and updating the driver profile for the driver by collecting information about the driver and behaviors of the driver.

8. The computer-implemented method of claim 1, wherein the driver profile comprises a static portion and a dynamic portion.

9. A system for enhancing vehicle-to-everything applications, the system comprising:
a memory comprising computer readable instructions; and
a processing device for executing the computer readable instructions for performing a method, the method comprising:
calculating, by the processing device, a threat level for a driver of a vehicle based on a driver profile for the driver;
determining, by the processing device, whether the threat level is indicative of an unsafe condition; and
initiating, by the processing device, an intervention activity based at least in part on determining that the threat level is indicative of an unsafe condition.

10. The system of claim 9, wherein determining whether the threat level is indicative of an unsafe condition comprises comparing the threat level to a threat level threshold for the driver.

11. The system of claim 9, wherein the method further comprises updating the driver profile based at least in part on determining that the threat level is indicative of an unsafe condition.

12. The system of claim 9, wherein the intervention activity comprises presenting a warning message to the driver of the vehicle.

13. The system of claim 9, wherein the driver profile is stored in a local data store or a remote data store.

14. The system of claim 9, wherein the intervention activity comprises controlling the vehicle, wherein controlling the vehicle comprises applying brakes, applying throttle, or changing a direction of the vehicle.

15. The system of claim 9, wherein the method further comprises generating the driver profile for the driver by collecting information about the driver and behaviors of the driver.

16. The system of claim 9, wherein the driver profile comprises a static portion and a dynamic portion.

17. A computer program product for enhancing vehicle-to-everything applications, the computer program product comprising:
a computer readable storage medium having program instructions embodied therewith, wherein the computer readable storage medium is not a transitory signal per se, the program instructions executable by a processing device to cause the processing device to perform a method comprising:
calculating, by the processing device, a threat level for a driver of a vehicle based on a driver profile for the driver;
determining, by the processing device, whether the threat level is indicative of an unsafe condition; and
initiating, by the processing device, an intervention activity based at least in part on determining that the threat level is indicative of an unsafe condition.

18. The computer program product of claim 17, wherein calculating the threat level is further based on a driver profile for a driver of another vehicle.

19. The computer program product of claim 17, wherein the method further comprises generating the driver profile for the driver by collecting information about the driver and behaviors of the driver.

20. The computer program product of claim 19, wherein the method further comprises storing the driver profile in a cloud data repository.
